(19) United States
(12) Patent Application Publication
(10) Pub. No.: US 2003/0117250 A1
(43) Pub. Date: Jun. 26, 2003

(54) Inductive translator composed of two spools with respective cores

(76) Inventor: Juergen Schirmer, Heidelberg (DE)

Correspondence Address: Striker Striker & Stenby, 103 East Neck Road, Huntington, NY, 11743, US

(21) Appl. No.: 10/276,142

(22) PCT Filed: Mar. 21, 2001
(86) PCT No.: PCT/DE01/01075

(30) Foreign Application Priority Data
May 13, 2000 (DE) 100 23 592.1

(51) Int. Cl. H01F 21/06

(52) U.S. Cl. 336/131

(57) ABSTRACT

The invention concerns an inductive transmitter comprising two coils (1, 2), each with one core (3, 4). The two cores (3, 4) are capable of being moved relative to each other. Two systems are integrated in the transmitter that make it possible to simultaneously transmit data and/or energy, as well as the position of the two cores (3, 4) relative to each other. Finally, the transmission of data and/or energy takes place by means of induction, and the determination of the position of the two cores (3, 4) relative to each other takes place via a measurement of the magnetic field that exists between the two coils (1, 2).

### BACKGROUND OF THE INVENTION

The invention concerns an inductive transmitter comprising two coils, each with one core.

Such inductive transmitters are used to transmit data and/or energy between two parts that move in relation to each other, e.g., in the form of rotational transmitters, to transmit data and/or energy in rotating parts (e.g., steering wheels in motor vehicles), or in the form of linear transmitters in the case of parts that move linearly in relation to each other. The transmitters comprise two coils, each with one core, whereby the two cores are capable of being moved in relation to each other. The transmission of data and/or energy takes place by means of induction (transformer principle).

It is further known that the relative position of two parts capable of being moved in relation to each other can be determined using magnetic measurement methods.

If data and/or energy is to be transmitted, or if the position of two parts relative to each other is to be determined, the procedure so far was to use two separate systems, one of which served to transmit the data and/or the energy, and the other of which served to determine the relative position. This resulted in a need for more space, a large number of components, and high costs.

### ADVANTAGES OF THE INVENTION

In contrast, the inductive transmitter according to the invention having the features of claim 1 has the advantage that the transmitter is very small and compact. Since two separate systems having different functions are integrated in a single system, the number of individual parts is reduced. This results in cost savings while retaining the same functionality.

Advantageous further developments of the inductive transmitter indicated in claim 1 are made possible by the features listed in the dependent claims.

### SUMMARY OF THE DRAWINGS

Two exemplary embodiments of the invention are presented in the drawings and they are described in greater detail in the subsequent description.

FIG. 1 shows a sectional drawing through an inductive transmitter in the form of a rotational transmitter,

FIG. 2 shows a view of an inductive transmitter in the form of a linear transmitter, and

FIG. 3 shows a sectional drawing in the direction A-A according to FIG. 2.

### DESCRIPTION OF THE PREFERRED EMBODIMENTS

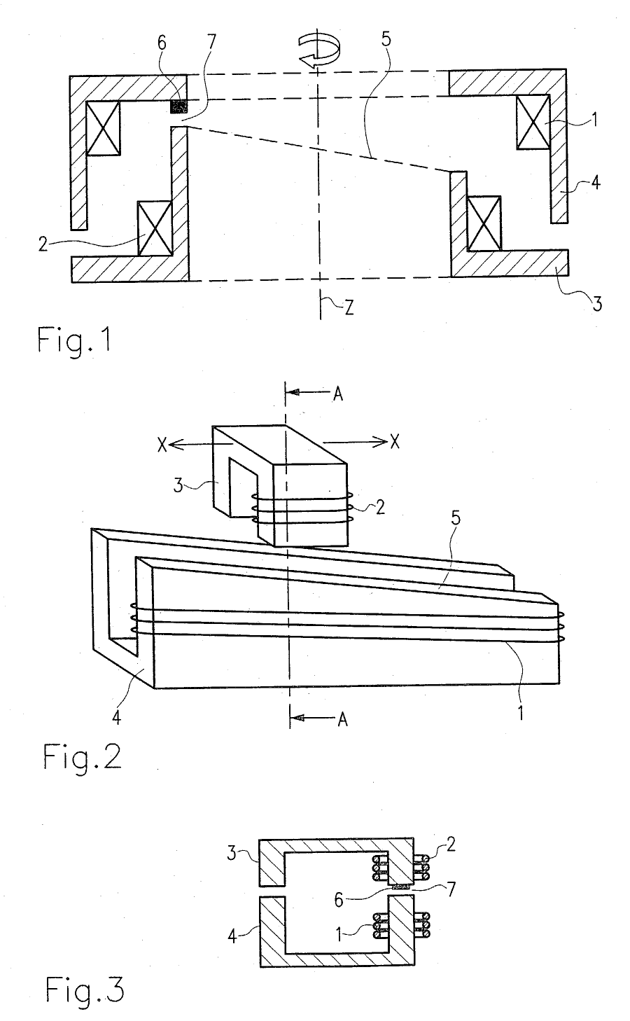

A first exemplary embodiment of the invention is shown in FIG. 1. In this exemplary embodiment, the inductive transmitter is designed as a rotational transmitter. It comprises two coils 1, 2, each with one annular core 3, 4, one of which-core 3 in the exemplary embodiment-is supported in a fashion that allows it to rotate around an axis Z. The cross-section of the two cores 3, 4 can be designed in the shape of an “L”. The arm of the “L” of core 3 facing core 4 is equipped with a contour 5, an incline in this case. A magnetic field-sensitive sensor 6 is located on the core 4 opposite to the incline, which said sensor can be designed as a Hall-effect sensor, a magnetoresistive sensor, or the like.

As a result of the contour 5 designed as an incline, the air gap 7 between the two cores 3 and 4 changes when core 3 rotates around the axis Z. This change in the air gap 7 causes a change in the magnetic flux that can be measured with the magnetic field-sensitive sensor 6. The measured magnetic flux is directly proportional to the angle of rotation between the two cores 3 and 4.

Using this embodiment, it is possible to not only transmit data and/or energy, it is also possible to determine the relative position of the two cores 3 and 4 in relation to each other.

FIGS. 2 and 3 show a further exemplary embodiment, in the case of which the inductive transmitter is designed as a linear transmitter. With such a linear transmitter, it is possible in the case of removable seats in motor vehicles, for example, to transmit signals from operator elements and side air bags, or energy for seat heating, or servomotors; additionally, the position of the seats can be measured in vehicles with automatic seat adjustment.

The linear transmitter according to FIGS. 2 and 3 functions according to the same principle as the rotational transmitter according to FIG. 1. Two coils 1, 2, each with one core 3, 4, are also provided, whereby the cross-sections of the two cores 3, 4 can be designed in the shape of a “U”. They can also be designed in the shape of an “L”, however. The coil 2 with its core 3 is capable of being moved in the direction of the arrow X in FIG. 2. On its side facing core 3, core 4 is equipped with a contour 5 that is formed as an incline, as in the exemplary embodiment according to FIG. 1. The incline is formed on at least one exposed arm of the “U”. A sensor 6 is located on core 3 on the side opposite to the incline on at least one exposed arm of the “U”. If both exposed arms of the “U” of core 4 are equipped with a contour 5, it is also possible to attach a sensor 6 to both exposed arms of the “U” of core 3.

When core 3 is moved in the direction of the arrow X in FIG. 2, the air gap 7 between the two cores 3 and 4 changes. This results in a change in the magnetic flux that can be measured by the sensor 6. The measured magnetic flux is directly proportional to the position of the two cores 3 and 4.

In both exemplary embodiments, only coil 1 in core 4 is current-carrying, while coil 2 in core 3 is not current-carrying, and its sole purpose is induction with coil 1 in core 3.

The preceding description of the exemplary embodiments according to the present invention is intended for illustrative purposes only and not for purposes of limiting the invention. Various changes and modifications are possible within the framework of the invention without leaving the scope of the invention or its equivalents.

What is claimed is:

1. Inductive transmitter comprising two coils (1, 2), each with one core (3, 4), having the following features:
the two cores (3, 4) are capable of being moved relative to each other,
two systems are integrated in the transmitter that make it possible to simultaneously transmit data and/or energy, as well as the position of the two cores (3, 4) relative to each other, and
the transmission of data and/or energy takes place by means of induction, and the determination of the position of the two cores (3, 4) relative to each other takes place via a measurement of the magnetic field that exists between the two coils (1, 2).

2. Inductive transmitter according to claim 1, whereby at least one coil (3, 4) is equipped with a contour (5).

3. The inductive transmitter according to claim 2, whereby the contour (5) of one core (3, 4) faces the other core (3, 4).

4. Inductive transmitter according to one of the preceding claims, whereby the contour (5) is designed as an incline.

5. Inductive transmitter according to one of the preceding claims, whereby a magnetic field-sensitive sensor (6) is provided.

6. Inductive transmitter according to claim 5, whereby the sensor (6) is designed as a Hall-effect sensor, a magnetoresistive sensor, or the like.

7. Inductive transmitter according to one of the preceding claims, whereby the sensor (6) and the contour (5) are situated opposite to each other.

8. Inductive transmitter according to one of the preceding claims, whereby the sensor (6) is located in the air gap (7) between the two cores (3, 4).

9. Inductive transmitter according to one of the preceding claims, whereby the sensor (6) is located on one core (3, 4), and the contour (5) is located on the other core (3, 4).

10. Inductive transmitter according to one of the preceding claims, whereby the sensor (6) and the contour (5) are located on the same core (3, 4).

11. Inductive transmitter according to one of the preceding claims, whereby the motion of the two cores (3, 4) relative to each other is a rotary motion.

12. Inductive transmitter according to one of the preceding claims, whereby the motion of the two cores (3, 4) relative to each other is a linear motion.

13. Inductive transmitter according to one of the preceding claims, whereby the cross-section of the cores (3, 4) is designed in the shape of an “L”, and the contour (5) is formed on an arm of the “L”.

14. Inductive transmitter according to one of the preceding claims, whereby the cross-section of the cores (3, 4) is designed in the shape of a “U”, and the contour (5) is formed on at least one exposed arm of the “U”.
